(19) United States
(12) Patent Application Publication
(10) Pub. No.: US 2003/0147080 A1
(43) Pub. Date: Aug. 7, 2003

(54) Method & apparatus for open path gas detection

(75) Inventors: Randall G. Sarkis, Chaska, MN (US); John M. Jarvis, Eden Prairie, MN (US)

Correspondence Address: MERCHANT & GOULD PC, P.O. BOX 2903, MINNEAPOLIS, MN, 55402-0903, US

(73) Assignee: Detector Electronics Corporation, Bloomington, MN (US)

(21) Appl. No.: 10/359,526

(22) Filed: Feb. 5, 2003

Related U.S. Application Data
(60) Provisional application No. 60/354,837, filed on Feb. 5, 2002.

(51) Int. Cl. G01N 21/00

(52) U.S. Cl. 356/437

(57) ABSTRACT

An apparatus and method for open-path gas detection. The apparatus includes a radiation source and first and second radiation detectors sensitive to radiation in first and second spectral bands. The long cut-off wavelength of the second spectral band is longer than the long cut-off wavelength of the first spectral band, and the short cut-off wavelength of the second spectral band is shorter than the short cut-off wavelength of the short spectral band, such that the second spectral band is wider than and completely overlaps the first spectral band. Radiation from the radiation source passes through the area to be checked for gas, and is partially absorbed if gas is present. The path between the radiation source and the first and second radiation detectors need not be enclosed, and may exceed 100 meters in length. A processor compares intensity signals from the radiation detectors with a threshold value, and generates an output signal indicating a presence of gas based on the comparison. The method includes the steps of passing radiation through an area, and sensing radiation that has passed through the area within first and second spectral bands, wherein the long cut-off wavelength of the second spectral band is longer than the long cut-off wavelength of the first spectral band, and the short cut-off wavelength of the second spectral band is shorter than the short cut-off wavelength of the short spectral band. The intensities in the spectral bands are compared with a threshold value, and the presence of gas is indicated based on the comparison.

### BACKGROUND OF THE INVENTION

The invention relates to an apparatus and method for detecting gas. More particularly, the invention relates to an apparatus and method for detecting the presence of gas along an open path, by measuring selective absorption of radiation characteristic of the gas being detected.

Although many gases are partially or completely transparent to visible light, most gases absorb electromagnetic radiation in at least a narrow wavelength band. For example, many hydrocarbon gases absorb electromagnetic radiation in the near infrared portion of the electromagnetic spectrum.

However, gases do not absorb radiation uniformly across the entire electromagnetic spectrum. That is, a particular gas may be a powerful absorber of radiation at certain wavelengths, while freely passing radiation at other nearby wavelengths.

Thus, it is possible to detect a particular gas by passing radiation through an area wherein the presence of that gas is suspected, measuring the intensity of radiation in a sample wavelength band that is known to be absorbed and in a different reference wavelength band known not to be absorbed, and comparing the relative intensities of the radiation in these two offset wavelength bands.

In such a case, a low intensity in a spectral band subject to absorption combined with a high intensity in a spectral band not subject to absorption indicates the presence of the gas in question. A high intensity in both bands indicates that the gas is not present. A low intensity in both bands generally indicates an obstruction in the path of the radiation.

Thus, this arrangement is able to distinguish between the presence of gas between a beam and a receiver, and an incidental obstacle between the beam and the receiver.

It is noted that the term “gas” as used herein applies not only to substances that are commonly considered to be gaseous at room temperature and pressure. Rather, the term is used herein to refer to any substance that may be freely suspended in or mixed with air. Thus, vapors from materials commonly considered to be liquids, such as gasoline, are also considered to be gases for the purpose of this application.

One application of this approach is so-called “open-path” gas detection. In open-path gas detection, a radiation source and one or more radiation sensors are arranged a substantial distance apart, in some cases up to several hundred meters. It is not necessary to enclose or the area between them, or to provide the gas in a sample cell or other enclosure. Hence, the path therebetween is considered “open”.

Open path gas detection is particularly useful in applications wherein it is impractical, impossible, or undesirable to enclose both the source and the sensors. Suitable applications include, but are not limited to, gas detection in ducts, buildings and other large enclosed volumes, and outside areas.

However, one drawback of open-path gas detection is that it is sensitive to conditions between the source and the sensors. Although solid objects typically are easily identified by a decrease in the intensity in both the sample and reference wavelength bands, certain environmental conditions selectively affect one wavelength band more than another.

For example, radiation is easily attenuated by the presence of materials between the radiation source and the sensors. For example, for near infrared radiation, water, in particular water vapor, and suspended particulates such as dust are of special concern. Absorption of electromagnetic radiation is a common cause of attenuation, although scattering, diffraction, and other processes may also contribute.

Environmental attenuation does not affect all wavelengths uniformly. For example, for both common dust and water, absorption varies substantially throughout the electromagnetic spectrum, so that certain wavelengths are more strongly attenuated than other wavelengths.

As a consequence, although it is necessary for the reference band to be sensitive to different wavelengths than the sample band in order to be useful for detecting gas, this very feature can produce errors.

If a beam is attenuated, such as by water vapor present between the radiation source and the sensors, radiation in a reference band that is at a different wavelength than the sample band will be subject to a decrease in intensity that is different from the decrease in intensity in the sample band itself. An example of these circumstances is illustrated in FIG. 1.

FIG. 1 shows a plot of received signal strength 10 as a function of wavelength 12, with a sample beam 16, a first reference beam 14 with a shorter wavelength than the sample beam 16, and a second reference beam 18 with a longer wavelength than the sample beam 16.

The gas absorption 20 represents a decrease in the intensity of the received radiation due to the presence of gas between the source and the sensors. A comparison of the decreased intensity of the sample beam 16 with the intensities of the first and/or second reference beams 14 and 18 is relied upon to indicate the presence of gas.

However, the strength of each of the first reference beam 14, sample beam 16, and second reference beam 18 is decreased due to signal attenuation 22. As previously noted, signal attenuation 22 is commonly a function of wavelength. As illustrated, in the portion of the electromagnetic spectrum under consideration, signal attenuation 22 is such that shorter wavelengths are more strongly attenuated than longer wavelengths. Thus, the first reference beam 14, which has a shorter wavelength than the sample beam 16, will decrease in intensity more than the sample beam 16. Conversely, the second reference beam 18, which has a longer wavelength than the sample beam 16, will decrease in intensity less than the sample beam 16.

Thus, regardless of whether a reference beam has a longer or a shorter wavelength than a sample beam, environmental attenuation can alter the relationship between the sample beam and the reference beam. This can result in false readings, as illustrated in FIG. 2.

FIG. 2 shows a plot of received signal strength 30 as a function of wavelength 32.

In the case of no attenuation 34, shown for comparison, both a first reference band 36 that has a shorter wavelength than the sample band 38, and a second reference band 40 that has a longer wavelength than the sample band 38, will have comparable intensity to the sample band 38.

However, a false negative 34′ may result if attenuation is present and a first reference band 36′ of shorter wavelength than the sample band 38′ is relied upon. In that case, although both the first reference band 36′ and the sample band 38′ are decreased in intensity due to environmental attenuation, the first reference band 36′ decreases more than the sample band 38′. Thus, even if gas were present as well, further decreasing the sample band 38′ but not the first reference band 36′, it might not be detected.

Conversely, a false positive 34″ may result if attenuation is present and a second reference band 40″ of longer wavelength than the sample band 38″ is relied upon. In that case, although both the second reference band 40″ and the sample band 38″ are decreased in intensity due to environmental attenuation, the second reference band 40″ decreases less than the sample band 38″. Thus, even if no gas were present to further decrease the sample band 38″ but not the second reference band 40″, the presence of gas might be indicated.

As seen, the effects of attenuation are a significant problem with known open-path gas detectors.

It is noted that FIGS. 1 and 2 show exemplary cases only. For example, as shown in FIG. 1, the receiver illumination 13 is constant across the range of wavelengths shown. That is, the intensity projected by a radiation source towards a receiver as a whole (and its individual sensors) is uniform with respect to wavelength. In practice, the receiver illumination 13 may vary somewhat, although over the ranges envisioned for the claimed invention it is nearly uniform. However, this is exemplary only; it is not necessary for the receiver illumination 13 to be uniform, it is merely shown to be so for purposes of clarity.

Likewise, as shown, the first reference beam 14, sample beam 16, and second reference beam 18 are shown to be of equal intensity. The relative intensity of the beams depends largely upon the whether the receiver illumination 13 is uniform; as previously noted, uniform receiver illumination is exemplary only. Similarly, it is exemplary only for the first reference beam 14, sample beam 16, and second reference beam 18 to have equal intensity.

It is also noted that although the signal attenuation 22 is shown to affect shorter wavelengths more than longer wavelengths, and is shown to be linear in its effect with respect to wavelength, this is exemplary only. Depending on the precise source of the attenuation and the portion of the electromagnetic spectrum under consideration, signal attenuation 22 may be non-linear, and/or may affect longer wavelengths more than shorter wavelengths.

It is known to attempt to overcome the difficulties inherent conventional systems by using three bands. Such systems are sensitive to a sample band, a first reference band having a shorter wavelength than the sample band, and a second reference band having a longer wavelength than the sample band.

However, such devices suffer from technical limitations. First, if the open path to be protected is of substantial length, typically beyond a few meters, adjusting the radiation detectors so that they are properly aligned with the radiation source becomes a significant difficulty. As the number of radiation sensors increases, the difficulty also increases. As a practical matter, it is far more difficult to adjust three sensors so that they are all properly aligned than it is to adjust only two.

In addition, the use of a third detector, with its associated alignment system, power source, lenses, etc. increases the complexity of the devices. The need to provide processing support for the third signal from the additional detector likewise makes the device still more complex. Increasing complexity typically results in greater cost, reduced reliability in use, and a higher scrap rate in manufacturing.

It is also known to attempt to overcome the difficulties inherent conventional systems by using a filter system that passes two separate reference bands, one having a shorter wavelength than the sample band, and one having a longer wavelength than the sample band, and detecting both of these reference bands with a sensor.

However, it is extremely difficult and expensive to produce such a filter, sometimes referred to as a dual-pass or dual band-pass filter. This is especially true when the dual-pass filter is intended to have precise cut-off wavelengths, as is often desirable for gas detection applications.

For at least these reasons, conventional two beam, three beam and dual-peak filter systems are not entirely satisfactory.

### SUMMARY OF THE INVENTION

It is the purpose of the claimed invention to overcome these difficulties, thereby providing an improved apparatus and method for detecting gas along an open path.

It is more particularly the purpose of the claimed invention to provide an apparatus and method of open-path gas detection that is resistant to false positives and negatives due to attenuation of the radiation, while maintaining good sensitivity for detecting gas.

As may be seen from the following descriptions of exemplary embodiments, a method or apparatus in accordance with the principles of the claimed invention utilizes radiation in a reference band extending both above and below the sample band.

An exemplary embodiment of a method for gas detection in accordance with the principles of the claimed invention includes the steps of passing radiation through an area, and sensing radiation that has passed through the area.

The radiation is sensed and measured within a first spectral band that is defined by a first long cut-off wavelength and a first short cut-off wavelength. The radiation is also sensed and measured within a second spectral band that is defined by a second long cut-off wavelength and a second short cut-off wavelength.

The second long cut-off wavelength is longer than the first long cut-off wavelength, and the second short cut-off wavelength is shorter than the first short cut-off wavelength. That is, the second spectral band is broader than, and includes the entirety of, the first spectral band.

For exemplary purposes, the first spectral band may be considered to be a sample band, and the second spectral band may be considered to be a reference band.

The radiation intensities in the first and second band are compared with at least one threshold value. The comparison process may include determining a ratio of the intensities of one of the first and second bands relative to the other, and comparing this to a predetermined minimum or maximum numeric value. However, this particular comparison is exemplary only.

The presence of gas within the area is then indicated, if appropriate according to the comparison.

By measuring radiation in a reference band or bands extending both above and below the sample band, a method in accordance with the principles of the claimed invention avoids both false positive and false negative alarms due to attenuation, as may be seen from FIG. 3.

FIG. 3 shows a plot of received signal strength 50 as a function of wavelength 52, with a sample beam 56, and a reference beam 54 that is broader than and entirely overlaps the sample beam 56.

The gas absorption 60 represents a decrease in the intensity of the received radiation due to the presence of gas between the source and the sensors. A comparison of the decreased intensity of the sample beam 56 with the intensity of the reference beam 54 is relied upon to indicate the presence of gas.

In addition, the strengths of the reference beam 54 and the sample beam 56 are decreased due to signal attenuation 62. As previously noted, and as similarly displayed in FIG. 1 with regard to conventional sensors, signal attenuation 22 is commonly a function of wavelength. As illustrated, in the portion of the electromagnetic spectrum under consideration, signal attenuation 22 is such that shorter wavelengths are more strongly attenuated than longer wavelengths.

However, despite the variation in signal attenuation across the different wavelengths, because the reference beam 54 extends both above and below the sample beam 56, the decrease in the strength of the reference beam 54 is proportionally similar to the decrease in the strength of the sample beam 56.

Thus, as shown in FIG. 4, false readings are avoided.

In the case of no attenuation 74, shown for comparison, both the reference band 76 and the sample band 78 have comparable intensity.

In the case of both attenuation and gas 74′, the intensity of the reference band 76′ is higher than that of the sample band 78′, as would occur in the presence of gas without attenuation. Although the reference band 76′ is decreased in intensity due to the attenuation, the strength of the sample band 78′ is also decreased by a corresponding amount due to the attenuation. In addition, due to the presence of gas, the sample band 78′ is further reduced. Thus, a true positive condition results, indicating the presence of gas.

In the case of attenuation without gas 74″, the reference band 76′ and the sample band 78′ have comparable intensity, as would occur in the case wherein there is no attenuation and no gas. Although the reference band 76′ is decreased in intensity due to the attenuation, the sample band 78′ is also decreased by a corresponding amount due to the attenuation. Thus, a true negative condition results, indicating the absence of gas.

An exemplary embodiment of an apparatus for gas detection in accordance with the principles of the claimed invention includes a radiation source, a first radiation detector, and a second radiation detector. The first detector is sensitive to radiation in a first spectral band, and the second radiation detector is sensitive to radiation in a second spectral band.

The first spectral band is defined by a first long cut-off wavelength and a first short cut-off wavelength. The second spectral band is defined by a second long cut-off wavelength and a second short cut-off wavelength. The second long cut-off wavelength is longer than the first long cut-off wavelength, and the second short cut-off wavelength is shorter than the first short cut-off wavelength.

The first radiation detector generates a first signal corresponding to the intensity of radiation detected in the first spectral band. The second radiation detector generates a second signal corresponding to the intensity of radiation detected in the second spectral band.

A processing unit is in communication with the first and second radiation detectors. The processing unit is adapted to compare the first and second signals with at least one threshold value, and to indicate the presence of gas based on this comparison.

It will be appreciated by those knowledgeable in the art that the advantages explained above and illustrated in FIGS. 3 and 4 apply equally to other embodiments of a method and apparatus in accordance with the principles of the claimed invention.

Thus, the claimed invention is resistant to false positives and false negatives for open-path gas detection.

In particular, the claimed invention has excellent resistance to false positives and negatives caused by beam attenuation, while still being effective at detecting gas. It is noted that the source of the beam attenuation is not a limiting factor with the claimed invention. That is, the claimed invention has excellent resistance to false positives and negatives caused by beam attenuation, regardless of both the source of the attenuation (i.e. water vapor, precipitation, dust, other suspended particulates, etc.) and the mode of the attenuation (i.e. absorption, scattering, diffraction, etc.).

### BRIEF DESCRIPTION OF THE DRAWINGS

Like reference numbers generally indicate corresponding elements in the figures.

FIG. 1 illustrates attenuation as applicable to a sample band and references bands of higher and lower wavelength, according to prior art.

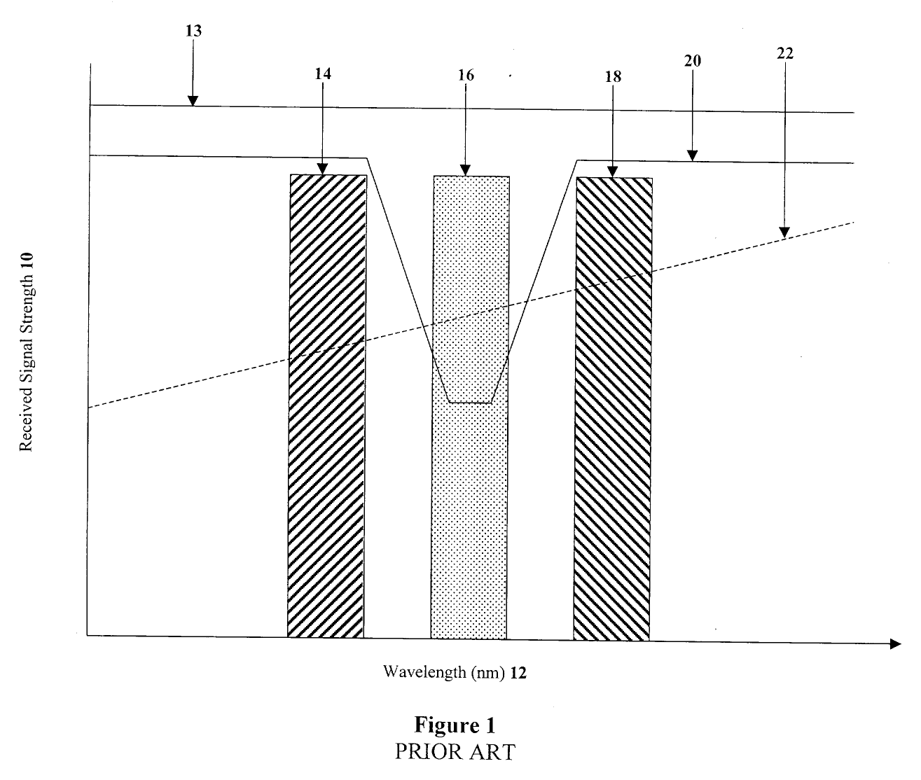

FIG. 2 illustrates results of attenuation as applied to FIG. 1, according to prior art.

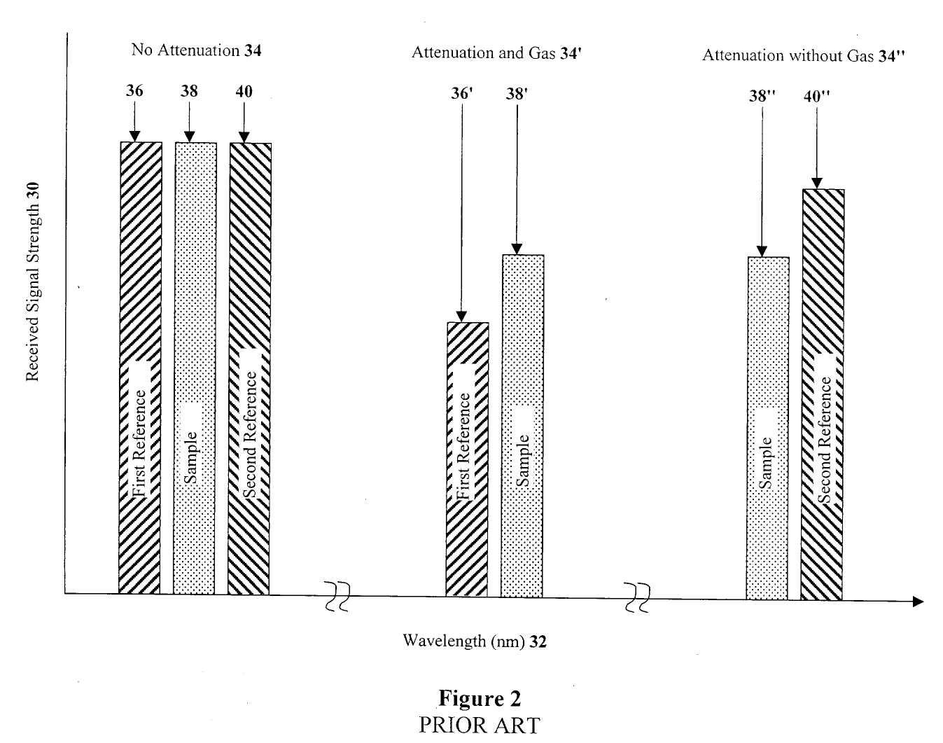

FIG. 3 illustrates attenuation as applicable to an exemplary method in accordance with the principles of the claimed invention.

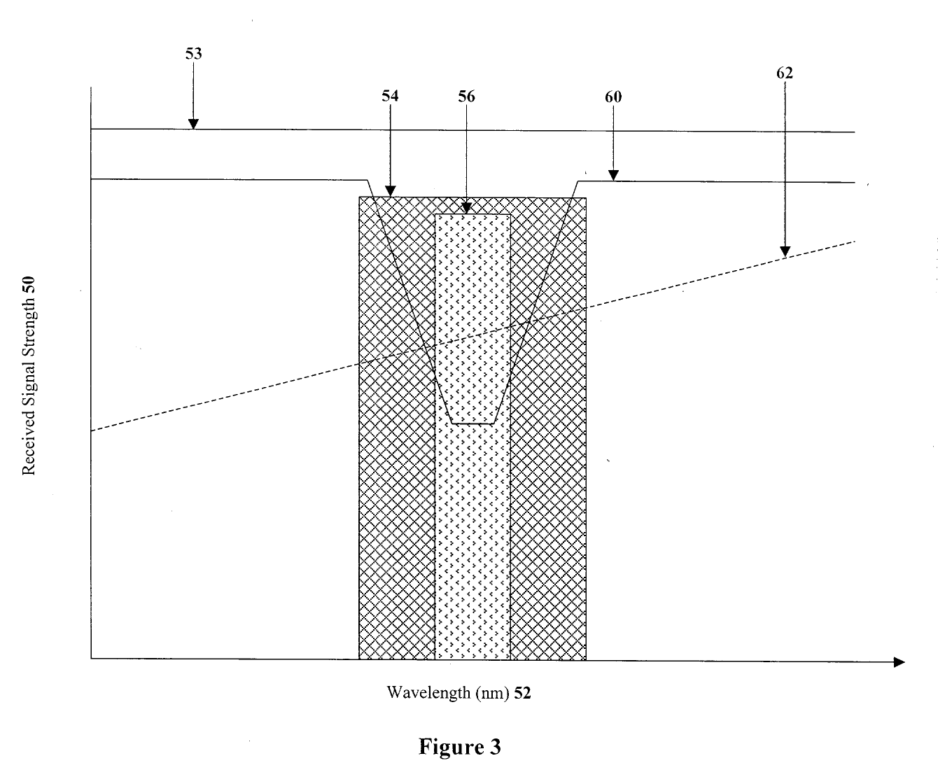

FIG. 4 illustrates results of attenuation as applied to FIG. 3.

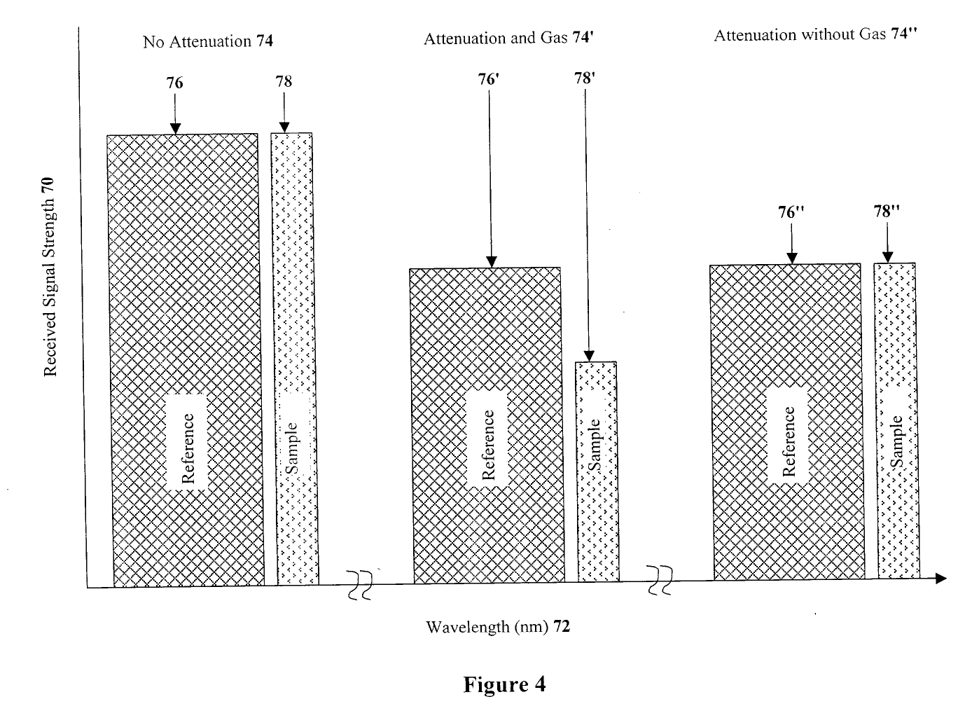

FIG. 5 illustrates an embodiment of an apparatus in accordance with the principles of the claimed invention in schematic form.

FIG. 6 illustrates exemplary wavelength bands for a device of FIG. 5.

FIG. 7 illustrates another embodiment of an apparatus in accordance with the principles of the claimed invention in schematic form, with multiple first and second radiation detectors.

FIG. 8 illustrates exemplary wavelength bands for a device of FIG. 7.

FIGS. 9A and 9B illustrate an exemplary arrangement of sensors for an apparatus in accordance with the principles of the claimed invention in schematic form.

### DETAILED DESCRIPTION OF THE PREFERRED EMBODIMENT

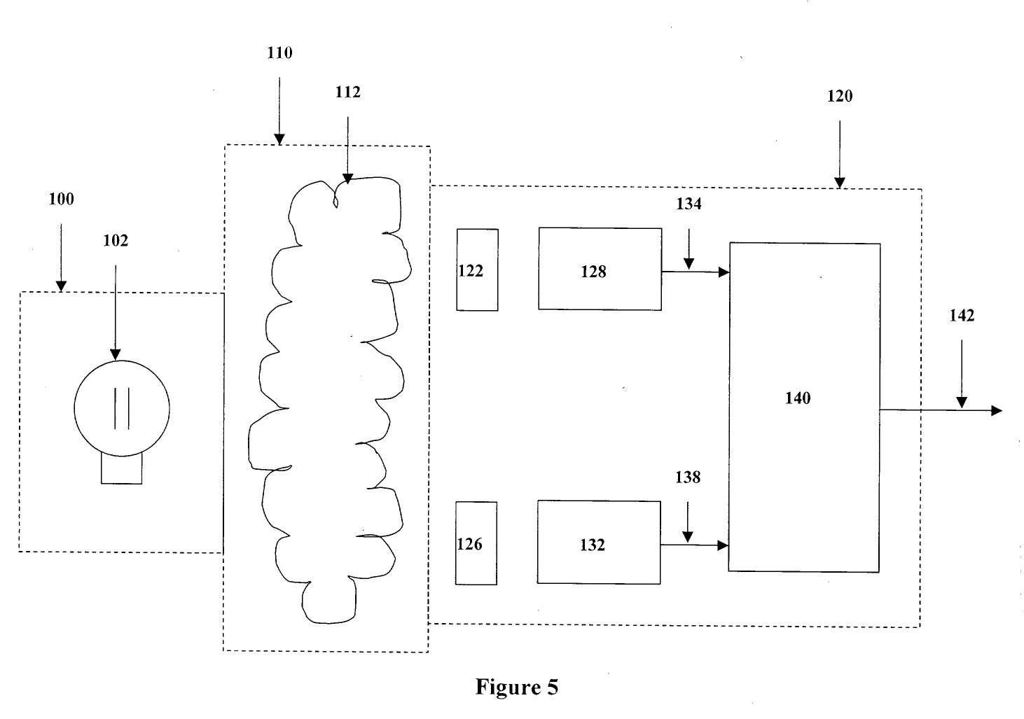

Referring to FIG. 5, an embodiment of an apparatus for open-path gas detection in accordance with the principles of the claimed invention includes a transmitter 100 and a receiver 120, with an area 110 therebetween.

The transmitter 100 has at least one radiation source 102 for emitting electromagnetic radiation.

For certain embodiments, it is convenient that the radiation source 102 produces radiation substantially in the near-infrared portion of the electromagnetic spectrum, since many common gases have prominent absorption lines in the near infrared. However, this is exemplary only, and radiation sources 102 that emit radiation in other portions of the electromagnetic spectrum, and/or emit little or no radiation in the near infrared, may be equally suitable.

In a preferred embodiment, the radiation source 102 will be a flash lamp, which alternately flashes on and off. In a more preferred embodiment, the radiation source 102 will be a Xenon flash lamp. In a still more preferred embodiment, the radiation source 102 will include multiple redundant flash lamps. However, such arrangements are exemplary only, and other radiation sources 102 may be equally suitable. Suitable radiation sources also include, but are not limited to, incandescent lamps. Radiation sources are known, and are not described further herein.

In the area 110 between the transmitter 100 and the receiver 120, there may be gas 112 present. If gas 112 is present in the area 110, radiation from the transmitter 100 passes therethrough en route to the receiver 120.

The receiver 120 includes a first radiation detector 128 and a second radiation detector 132 for detecting radiation. Each of the first and second radiation detectors 128 and 132 are sensitive to at least a portion of the radiation emitted by the radiation source 102.

The first radiation detector 128 detects radiation in a first spectral band 150. The second radiation detector 132 detects radiation in a second spectral band 160.

The first radiation detector 128 generates a first intensity signal 134 that is representative of the intensity of the radiation in the first spectral band 150 as received by the first radiation detector 128. The second radiation detector 132 likewise generates a second intensity signal 138 that is representative of the intensity of the radiation in the second spectral band 160 as received by the second radiation detector 132.

The first and second intensity signals 134 and 138 may be in any suitable form. Suitable forms include but are not limited to electrical, optical, and wireless (i.e. radio-wave) signals. Signal generation and transmission are well known, and are not further described herein.

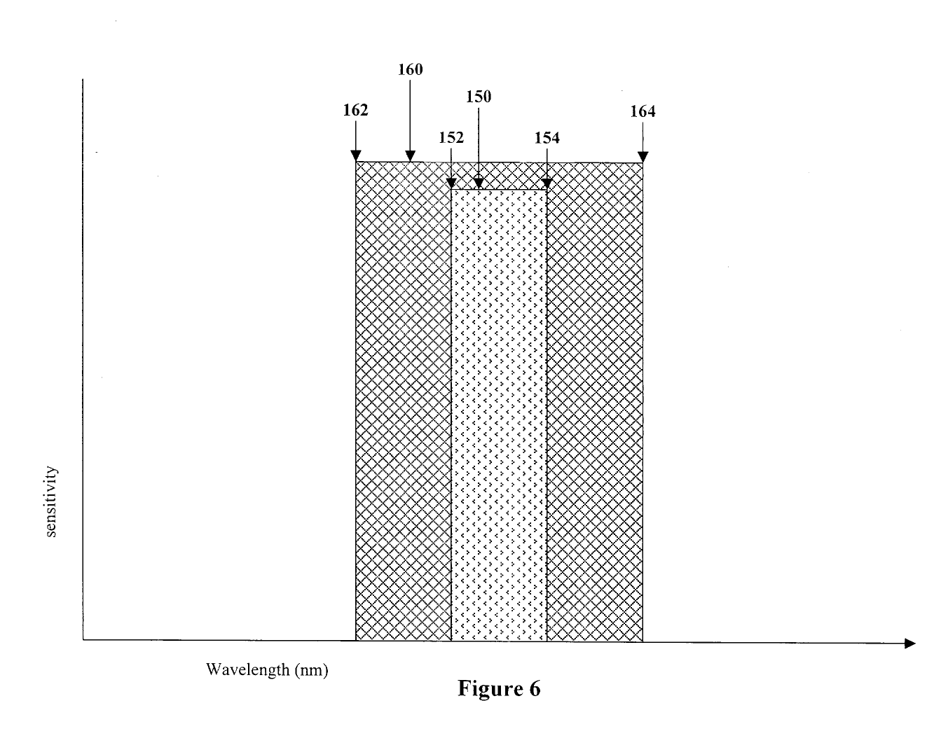

In an embodiment of an apparatus in accordance with the principles of the claimed invention, as illustrated in FIG. 6, the first spectral band 150 is defined by a first short cut-off wavelength 152 and a first long cut-off wavelength 154, and the second spectral band 160 is defined by a second short cut-off wavelength 162 and a second long cut-off wavelength 164.

As may be seen from FIG. 6, the second long cut-off wavelength 164 is longer than the first long cut-off wavelength 154, and the second short cut-off wavelength 162 is shorter than the first short cut-off wavelength 152.

Thus, as may be seen, the second spectral band 160 is wider than and entirely overlaps the first spectral band 150.

It is noted that, although the second spectral band 160 is shown to have a greater height, and hence a greater intensity, than the first spectral band 150, this is exemplary only, and is done for clarity. The intensities of radiation in the first and second spectral bands 150 and 160 may in some instances be equal, and the first spectral band 150 may in some instances have an intensity greater than that of the second spectral band 160.

It is also noted that, although the second spectral band 160 is shown to be centered at the same wavelength as the first spectral band 150, i.e., it extends an equal distance past the first spectral band 150 in both the long and short wavelength directions of the spectrum, this is exemplary only. Arrangements wherein the first and second spectral bands 150 and 160 are not centered at the same wavelength (and wherein, consequently, the second spectral band 160 extends further beyond the first spectral band 150 in one direction than in the other) may be equally suitable.

As illustrated in FIG. 6, the wavelength cut-offs 152, 154, 162, and 164 are perfectly sharp and vertical. However, this is exemplary only, and is shown for illustrative purposes. In general, it is preferable that the wavelength cut-offs 152, 154, 162, and 164 are as steep as is practical, so as to provide well-defined boundaries to the spectral bands 150 and 160. However, this is largely a matter of convenience; it is not necessary that the wavelength cut-offs 152, 154, 162, and 164 are perfectly sharp. Indeed, in practice producing such a vertical cut-off is often problematical.

In instances wherein the wavelength cut-offs 152, 154, 162, and 164 are not perfectly sharp, those wavelengths 152, 154, 162, and 164 may be defined in a variety of ways. For example, filters, sensors, and other wavelength-sensitive components are sometimes described as having a half power band width, or HPBW. The HPBW for a given component is the range of wavelengths wherein intensity is at least half the peak intensity. That is, for a filter that passes 100% of incoming radiation at its peak, the HPBW would be the range of wavelengths for which at least 50% of incoming radiation is passed. In certain embodiments, the HPBW may be considered to define the wavelength cut-offs 152, 154, 162, and 164.

However, such a standard is exemplary only. Other standards for determining what constitutes the cut-off wavelengths 152, 154, 162, and 164 for components wherein such cut-offs are not vertical may be equally suitable.

For certain embodiments, in particular embodiments wherein the radiation source 102 produces radiation substantially in the near-infrared portion of the electromagnetic spectrum, it is convenient that the first and second radiation detectors 128 and 132 are sensitive to first and second spectral bands 150 and 160 in the near infrared. However, this is exemplary only, and first and second radiation detectors 128 and 132 that are sensitive to radiation in other portions of the electromagnetic spectrum, in addition to and/or instead of the near infrared, may be equally suitable.

Suitable radiation detectors include, but are not limited to, photodetectors and charge-coupled devices (CCDs). Radiation detectors are known, and are not described further herein.

It is noted that many common radiation detectors have sensitivity ranges that are broader than is necessary for the claimed invention. In order to conveniently limit the sensitivity of the first and second radiation detectors 128 and 132 to only the first and second spectral bands 150 and 160, an embodiment of an apparatus in accordance with the principles of the claimed invention may include filters.

In particular, an embodiment of an apparatus in accordance with the principles of the claimed invention may include a first filter 122 interposed between the radiation source 102 and the first radiation detector 128. Likewise, it may include a second filter 126 interposed between the radiation source 102 and the second radiation detector 132. The first and second filters 122 and 126 pass only light within the first and second spectral bands 150 and 160, respectively.

It is pointed out that, although only a single structure is shown in FIG. 5 to represent each of the first and second filters 122 and 126, in some cases either or both the first and second filters 122 and 126 may consist of or include more than one physical component each.

For example, it may be advantageous to combine a low-pass filter that passes only radiation below the long cut-off wavelength 154 with a high-pass filter that passes only radiation above the short cut-off wavelength 152 in order to produce the first filter 122.

Likewise, it may also be advantageous that one or both of the first and second filters 122 and 126 are adjustable. For example, one or both of the first and second filters 122 and 126 may include a plurality of different filter elements, each of which may be selected individually, i.e. by mounting the elements on a wheel and rotating the wheel to bring a selected filter element into position. In this way, the first and second spectral bands 150 and 160 may be adjusted, so as to align with absorption wavelengths characteristic of different gases 112, and enable the apparatus to be used to detect a wide variety of different gases.

However, adjustable first and/or second filters 122 and/or 126 are exemplary only. It may be equally suitable to use fixed first and/or second filters 122 and/or 126 for certain applications.

Suitable filters are well known, and are not described further herein.

The use of filters, and in particular bandpass filters is exemplary only, and other configurations may be equally suitable. For example, for certain embodiments, it may be advantageous to omit filters entirely.

In such embodiments, it may be desirable to limit the effective sensitivity of the first and second radiation detectors 128 and 132 in some alternative fashion. Alternative methods include, but are not limited to, processing the first and second intensity signals 134 and 138 so as to identify thereby only radiation in the first and second spectral bands 150 and 160, and physically tuning the first and second radiation detectors 128 and 132 to be sensitive only to radiation in the first and second spectral bands 150 and 160.

Alternatively, first and second radiation detectors 128 and 132 may be used that are specifically sensitive only to the first and second spectral bands 150 and 160.

An apparatus for open-path gas detection in accordance with the principles of the claimed invention also includes a processor 140. The processor is in communication with the first and second radiation detectors 128 and 132, and receives the first and second intensity signals 134 and 138 therefrom.

The processor 140 is adapted to compare the first and second intensity signals 134 and 138 with at least one threshold value. The processor 140 is also adapted to generate an output signal 142 based on this comparison.

For example, in certain embodiments the comparison may consist of calculating a ratio of the magnitudes of the first and second intensity signals 134 and 138, and comparing this ratio to a predetermined value. In such embodiments, if the ratio is less than the predetermined value, an output signal 142 indicating the presence of gas is sent.

It is noted that a simple ratio of radiation in the first and second spectral bands 150 and 160 is typically non-linear. Consequently, in certain embodiments, the comparison may include a linearization algorithm that does produce a linear ratio. In this way, calculations and data processing can be simplified, and the resulting data are more easily interpreted by a human operator. However, the use of a linearization algorithm is exemplary only, and embodiments without such an algorithm may be equally suitable. Likewise, use of a ratio is itself exemplary, and other arrangements may be equally suitable.

A variety of units may be used for measuring the amount of gas present, and for determining an alarm state. One unit that is particularly suitable for open path gas detection is lower explosive limit meters, abbreviated LEL.m.

LEL.m is related to LEL, the percent lower explosive limit, which is conventionally used in point and volume gas detectors to measure concentrations of particular gases that represent a threat of explosion or combustion.

However, because open path gas detectors protect a linear path, rather than a single point or a volume, LEL has little meaning for open path detectors. For example, a uniform gas density of 1% along a 100 meter path produces a signal similar to that from a 1 meter diameter cloud of 100% gas somewhere along that path.

Instead, LEL.m represents the average density of a cloud of gas to be detected along the path, multiplied by the length of the cloud in meters along the path protected by the open path gas detector. Thus, LEL.m is a measure of the total quantity of gas present along the entirety of the protected path.

In certain embodiments of an apparatus in accordance with the principles of the claimed invention, the relative magnitudes of the first and second intensity signals 134 and 138 are used to determine the amount of gas present, as converted to LEL.m.

In such embodiments, the amount of gas present would be measured in LEL.m, and the alarm level would be set in LEL.m. The precise alarm level will vary depending upon features including but not limited to the particular gas, the expected conditions along the protected path, and the specific application. 1 LEL.m and 3 LEL.M are particularly suitable for many embodiments. However, these alarm levels are exemplary only, and a variety of other alarm levels may be equally suitable.

In particular, it may be suitable for the alarm levels to be adjustable, so that they may be set appropriately for a variety of situations. However, this also is exemplary only, and embodiments having alarm levels that are preset and fixed may be equally suitable.

It is emphasized that the comparison is not limited to a ratio only. The comparison may include a more complex algorithm, and/or may account for factors other than only the magnitudes of the first and second intensity signals 134 and 138.

Likewise, the output signal 142 may be more complex than a simple “gas present” alarm. For example, the output signal 142 may include information on the amount of gas present, based on the first and second intensity signals 134 and 138. Alternatively, the output signal 142 may consist of a signal indicating that gas is not present, so that in the event of malfunction or damage, the lack of an output signal 142 would not mask the evidence of gas when gas is in fact present.

A variety of processors may be suitable, including but not limited to digital and analog processors, and electrical and optical processors. Processors are well known, and are not described further herein.

As with the first and second intensity signals 134 and 138, the output signal 142 may be in any suitable form. Suitable forms include but are not limited to electrical, optical, and wireless (i.e. radio-wave) signals, and analog and digital signals. Signal generation and transmission are well known, and are not further described herein.

It is noted that an apparatus in accordance with the principles of the claimed invention is not limited to only those components described above. A variety of additional, optional components may be advantageous for certain embodiments.

For example, it may be advantageous for one or both of the transmitter 100 and the receiver 120 to include optics therein for adjusting the path and properties of the radiation. Suitable optics may include, but are not limited to, lenses, mirrors, beam splitters, and diffusers. Optics are well known, and are not further described herein.

Likewise, it may be advantageous for one or both of the transmitter 100 and the receiver 120 to include aiming mechanisms for aiming one or both of the transmitter 100 and the receiver 120, or elements thereof. As the distance between the transmitter 100 and the receiver 120 may be substantial for at least some embodiments, i.e. in excess of 100 meters, it may be advantageous to include aiming devices including but not limited to sighting scopes, off-beam indicators, and indicators for suggesting a suitable direction and/or distance to which the beam(s) should be adjusted in order to align with the radiation source 102. Aiming mechanisms are well known, and are not further described herein.

Furthermore, it may be advantageous to include additional signal processing mechanisms. For example, if the first and second radiation detectors 128 and 132 are analog detectors, and the processor 140 is a digital processor, it may be advantageous to include an analog to digital converter (ADC) to convert the first and second intensity signals 134 and 138 from analog into digital form. Other potentially advantageous signal processing mechanisms include, but are not limited to, filtering and noise reduction circuits. Signal processing mechanisms are well known, and are not further described herein.

In addition, motors for adjusting one or more components may be advantageous in certain embodiments. For example, in an embodiment wherein the first and second filters 122 and 126 are adjustable, it may be advantageous to include a motor for adjusting the first and second filters 122 and 126. Depending on the embodiment, this may for example enable remote adjustment of the first and second spectral bands 150 and 160.

Also, it is noted that although the transmitter 100 functions collectively, and the receiver 120 likewise functions collectively, and the individual elements thereof are illustrated together for clarity, these individual elements need not be built into a single physical unit.

For example, the first and second radiation detectors 128 and 132 may be mounted separately from one another, and may be aimed and controlled separately from one another. Likewise, it is not necessary for the processor 140 to be mounted together with the first and second radiation detectors 128 and 132.

Indeed, since the first and second intensity signals 128 and 132 may be radio waves or other signals that do not require wires or cables, it is not even necessary that the first and second radiation detectors 128 and 132 be in physical contact with either one another or the processor 140.

In particular, there may be a substantial distance between the processor 140 and the other components of the receiver 120.

Additionally, one or more of the elements of the transmitter 100 and/or the receiver 120 may be enclosed in housings. In particular, housings rated as explosion-proof may be particularly suitable. However, this feature is exemplary only, and embodiments with non-explosion-proof housings or no housings may be equally suitable. Housings are well-known, and are not detailed further herein.

Furthermore, it is noted that a variety wavelengths for both the first and the second spectral bands 150 and 160 may be suitable. It is generally advantageous to select sample bands wherein the gas that is to be detected is known to be highly absorptive. However, the precise wavelengths for different gases vary with the individual gases.

For example, for certain common hydrocarbon gases, suitable peak absorption wavelengths include, but are not limited to, 1.6 μm, 2.3 μm, and 3.3 μm. Thus, for an exemplary embodiment of an apparatus in accordance with the principles of the claimed invention that is to detect combustible hydrocarbons, it may be suitable to select the first and/or the second spectral band 150 and/or 160 to be centered on or near 1.6 μm, 2.3 μm, and/or 3.3 μm.

In a preferred embodiment of a gas detector in accordance with the principles of the claimed invention that is adapted to detect hydrocarbon gas, the first and second spectral bands 150 and 160 include the wavelength of 2.3 μm. This is suitable, in that infrared radiation with a wavelength of 2.3 μm is strongly absorbed by hydrocarbon gases, but wavelengths immediately surrounding 2.3 μm are not strongly absorbed by hydrocarbon gases.

In a more preferred embodiment, the first and second spectral bands 150 and 160 are at least approximately centered on the wavelength of 2.3 μm.

However, this is exemplary only. Other wavelengths may be equally suitable, both for hydrocarbon gases and for non-hydrocarbon gases. The center wavelengths of the first and second spectral bands 150 and 160 may vary considerably from embodiment to embodiment. The precise wavelength sensitivities appropriate for a particular embodiment will depend on a variety of factors, including but not limited to the type or types of gas that a given embodiment is meant to detect.

As previously noted, a first embodiment of an apparatus in accordance with the principles of the claimed invention utilizes spectral bands as illustrated in FIG. 5.

A variety of bandwidths may be suitable for the first and second spectral bands 150 and 160. In a preferred embodiment of a gas detector in accordance with the principles of the claimed invention that is adapted to detect hydrocarbon gas, the first and second spectral bands 150 and 160 may have bandwidths of approximately 0.10 and 0.30 μm, respectively.

However, these bandwidths are exemplary only. For example, for certain alternative embodiments, a bandwidth of approximately 30 nm for the first spectral band 150 and approximately 100 nm for the second spectral band 160 may be suitable. A wide variety of other bandwidths may be equally suitable, so long as the second spectral band 160 is broader than and extends higher and lower than the first spectral band 150.

It is in particular emphasized that although the first and second spectral bands 150 and 160 may be centered at the same wavelength, this is not required or even necessarily advantageous for all embodiments of the claimed invention. The difference between the first short cut-off wavelength 152 and the second short cut-off wavelength 162 may be greater than, equal to, or less than the difference between the first long cut-off wavelength 154 and the second long cut-off wavelength 164.

As noted previously, the particular bandwidths of the first and second spectral bands 150 and 160 may vary. Likewise, the relative bandwidths of the first and second spectral bands 150 and 160 may vary considerably. In a preferred embodiment, the bandwidth of the second spectral band 160 may be at least twice the bandwidth of the first spectral band 150. In a more preferred embodiment, the bandwidth of the second spectral band 160 may be at least three times the bandwidth of the first spectral band 150. However, this is exemplary only. With regard to relative band widths, it is only necessary that the second spectral band 160 is wider than, and includes the entirety of, the first spectral band 150.

It is noted that the selection of suitable first and second spectral bands 150 and 160 may not be based solely on the absorption and/or lack of absorption of the wavelengths therein by the target gas. Other factors also may influence the selection of appropriate first and second spectral bands 150 and 160.

Such factors include, but are not limited to, environmental considerations and equipment functionality.

For example, water strongly absorbs infrared radiation beginning at approximately 2.45 μm. As water vapor is common in certain environments, for certain embodiments the cut-off wavelengths 152, 154, 162, and 164 might be selected so that the first and/or second spectral bands 150 and 160 do not include wavelengths at 2.45 μm, due to environmental considerations.

Likewise, certain forms of conventional optical detectors are prone to a temperature dependent roll-off in responsivity vs. wavelength in the range of 2.45 μm. If optical detectors that function thusly are incorporated into an embodiment of the claimed invention, the cut-off wavelengths 152, 154, 162, and 164 might be selected so that the first and/or second spectral bands 150 and 160 do not include wavelengths at 2.45 μm, so as to maintain a desired level of equipment functionality.

However, such considerations are exemplary only. Factors instead of or in addition to those described may influence the selection of first and second spectral bands 150 and 160.

It is also emphasized that the claimed invention is not limited to detection of hydrocarbon gases only, or to detection of flammable gases only. Embodiments of the claimed invention may be suitable for detecting substantially any gas.

For example, certain embodiments of the claimed invention may be suitable for detecting gases that pose a risk of environmental degradation, such as refrigerants or fire suppressants. Likewise, certain embodiments may be suitable for detecting toxic or carcinogenic gases, such as industrial byproducts.

More particularly, embodiments of the claimed invention may be suitable for detecting gases including but not limited to chlorinated fluorocarbons (CFCs), hydrogen sulfide, halogens, bromine, hydrogen cyanide, etc.

In addition, embodiments of the claimed invention may be suitable for simultaneously and independently detecting more than one type of gas.

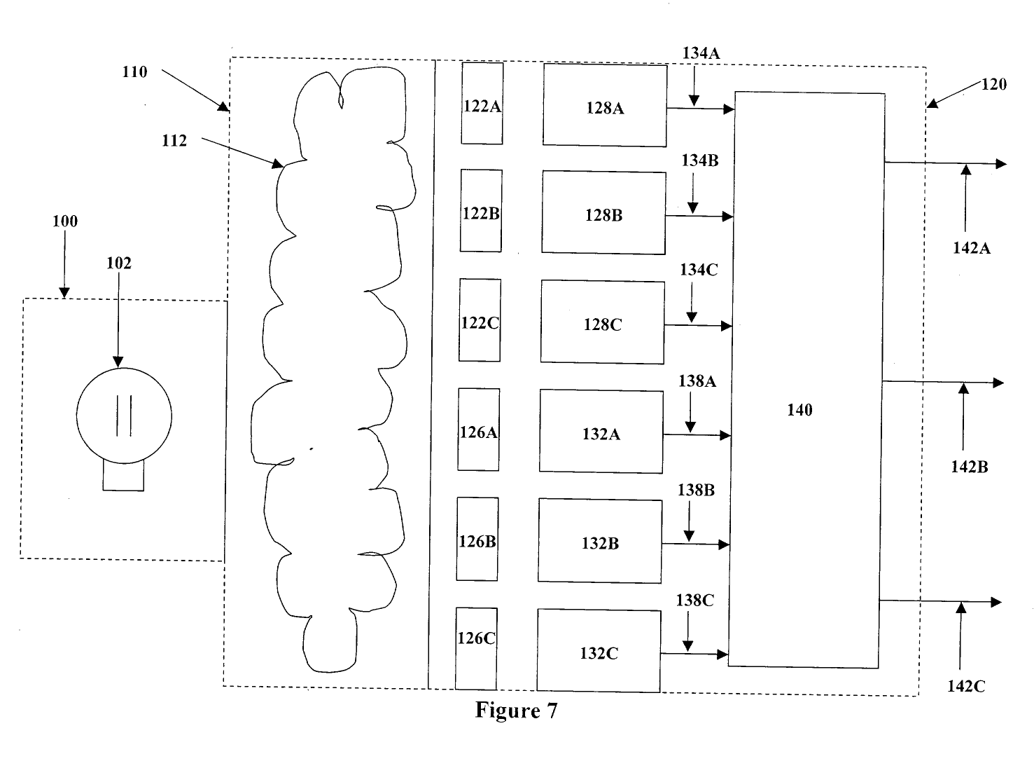

Referring to FIG. 7, an alternative embodiment of an apparatus for gas detection in accordance with the principles of the claimed invention may include a plurality of first and second radiation detectors to simultaneously detect a plurality of different gases. Such an embodiment is similar to that illustrated in FIG. 5, and many of the comments made previously with respect thereto also apply to the embodiment of FIG. 7.

As illustrated in FIG. 7, the receiver 120 for such an embodiment includes a first radiation detectors 128A, 128B, and 128C for detecting radiation. The receiver 120 also includes second radiation detectors 132A, 132B, and 132C for detecting radiation. Each of the first radiation detectors 128A, 128B, and 128C and second radiation detectors 132A, 132B, and 132C are sensitive to at least a portion of the radiation emitted by the radiation source 102.

In addition, each first radiation detector 128A, 128B, and 128C is associated with a second radiation detector 132A, 132B, and 132C, in the manner that the first radiation detector 128 shown in FIG. 5 is associated with the second radiation detector 132 also shown therein.

Returning to the embodiment shown in FIG. 7, each of the first radiation detectors 128A, 128B, and 128C detects radiation in a first spectral band 150A, 150B, or 150C. Each of the second radiation detectors 132A, 132B, and 132C detects radiation in a second spectral band 160A, 160B, or 160C.

Each of the first radiation detectors 128A, 128B, and 128C generates a first intensity signal 134A, 134B, and 134C that is representative of the intensity of the radiation in one of the first spectral bands 150A, 150B, and 150C as received by one of the first radiation detectors 128A, 128B, and 128C. Each of the second radiation detectors 132A, 132B, and 132C likewise generates a second intensity signal 138A, 138B, and 138C that is representative of the intensity of the radiation in one of the second spectral bands 160A, 160B, and 160C as received by one of the second radiation detectors 132A, 132B, and 132C.

As with the embodiment of FIG. 5, for the embodiment of FIG. 7 the first and second intensity signals 134A, 134B, 134C, 138A, 138B, and 138C may be in any suitable form.

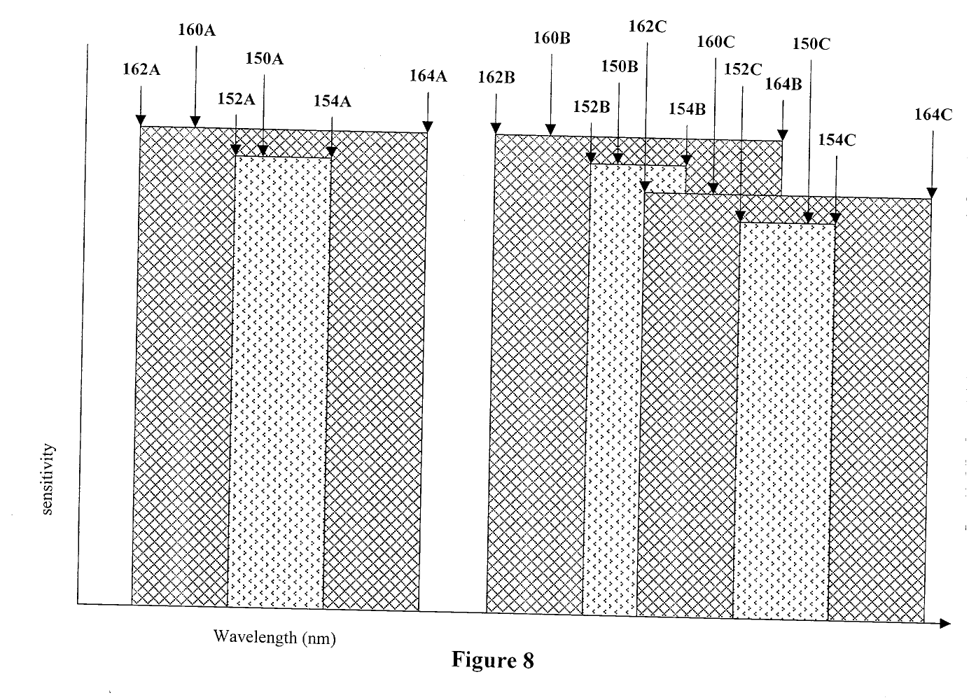

In an embodiment of an apparatus in accordance with the principles of the claimed invention, as illustrated in FIG. 8, each of the first spectral bands 150A, 150B, and 150C is defined by a first short cut-off wavelength 152A, 152B, and 152C, and a first long cut-off wavelength 154A, 154B, and 154C. Likewise, each of the second spectral bands 160A, 160B, or 160C is defined by a second short cut-off wavelength 162A, 162B, and 162C, and a second long cut-off wavelength 164A, 164B, and 164C.

As may be seen from FIG. 8, the second long cut-off wavelength 164A, 164B, and 164C for each second spectral band 160A, 160B, or 160C is longer than the first long cut-off wavelength 154A, 154B, and 154C for the first spectral band 150A, 150B, and 150C associated therewith. Also, the second short cut-off wavelength 162A, 162B, and 162C for each second spectral band 160A, 160B, or 160C is shorter than the first short cut-off wavelength 152A, 152B, and 152C for the first spectral band 150A, 150B, and 150C associated therewith.

As in FIG. 6, although certain spectral bands are shown to have a greater height, and hence a greater intensity, than others, this is exemplary only, and is done for clarity. The intensities of radiation in the various spectral bands may or may not be equal, and any spectral band may have an intensity higher or lower than any other spectral band.

Similarly, although each of the second spectral bands 160A, 160B, or 160C is shown to be centered at the same wavelength as their associated first spectral band 150A, 150B, and 150C, i.e., they extend an equal distance past the first spectral band 150A, 150B, and 150C in both the long and short wavelength directions of the spectrum, this is exemplary only. Arrangements wherein the one or more associated first and second spectral bands 150A, 150B, and 150C and 160A, 160B, and 160C are not centered at the same wavelength (and wherein, consequently, the second spectral band 160A, 160B, and 160C extends further beyond the first spectral band 150A, 150B, and 150C in one direction than in the other) may be equally suitable.

Furthermore, although as illustrated in FIG. 8 first spectral band 150C partially overlaps second spectral band 160B, with which it is not associated, and second spectral band 160C partially overlaps first and second spectral bands 150B and 160B, with which it is not associated, this is exemplary only. For embodiments sensitive to multiple first and second spectral bands, any or all of the spectral bands may overlap partially or completely with any or all of the other spectral bands with which they are not associated, so long as each of the second spectral bands 160A, 160B, and 160C is wider than and entirely overlaps its associated first spectral band 150A, 150B, and 150C.

In addition, although in FIG. 7 three first radiation detectors 128A, 128B, and 128C and three second radiation detectors 132A, 132B, and 132C are illustrated, and although in FIG. 8 three first spectral bands 150A, 150B, and 150C and three second spectral bands 160A, 160B, or 160C are illustrated, this is exemplary only. Embodiments with two first and second radiation detectors may be equally suitable; likewise embodiments with four or more first and second radiation detectors may be equally suitable.

Returning to FIG. 7, certain embodiments may include filters 122A, 122B, 122C, 126A, 126B, and 126C, similar to filters 122 and 126 described with respect to FIG. 5.

As shown in FIG. 7, a processor 140 in communication with the first radiation detectors 128A, 128B, and 128C and second radiation detectors 132A, 132B, and 132C receives the first and second intensity signals 134A, 134B, 134C, 138A, 138B, and 138C therefrom.

The processor 140 is adapted to compare first and second intensity signals 134A and 138A with at least one threshold value, and to generate an output signal 142A based on this comparison.

The processor 140 is also adapted to compare first and second intensity signals 134B and 138B with at least one threshold value, and to generate an output signal 142B based on this comparison. The processor 140 is further adapted to compare first and second intensity signals 134C and 138C with at least one threshold value, and to generate an output signal 142C based on this comparison. Depending on the outcome of these comparisons, the processor 140 sends output signals 142A, 142B, and 142C to indicate the presence of gas.

The spectral bands on which output signals 142A, 142B, and 142C ultimately are based may be different. Likewise, the threshold value(s) used for comparison of each of the first intensity signals 134A, 134B, and 134C with the second intensity signals 138A, 138B, and 138C may be different. Thus, the output signals 142A, 142B, and 142C may be indicative of different types of gas. In this fashion, multiple types of gas may be detected simultaneously and independently by the use of additional first and second radiation detectors 128 and 132.

Furthermore, regardless of the number of first and second radiation detectors 128 and 132 in a given embodiment, certain embodiments of the claimed invention may include additional sensors that are not used for detecting gas.

For example, for some embodiments it may be advantageous to include radiation detectors for detecting beam alignment or misalignment, and/or for assisting in aligning the radiation beam from the transmitter 100 to the receiver 120.

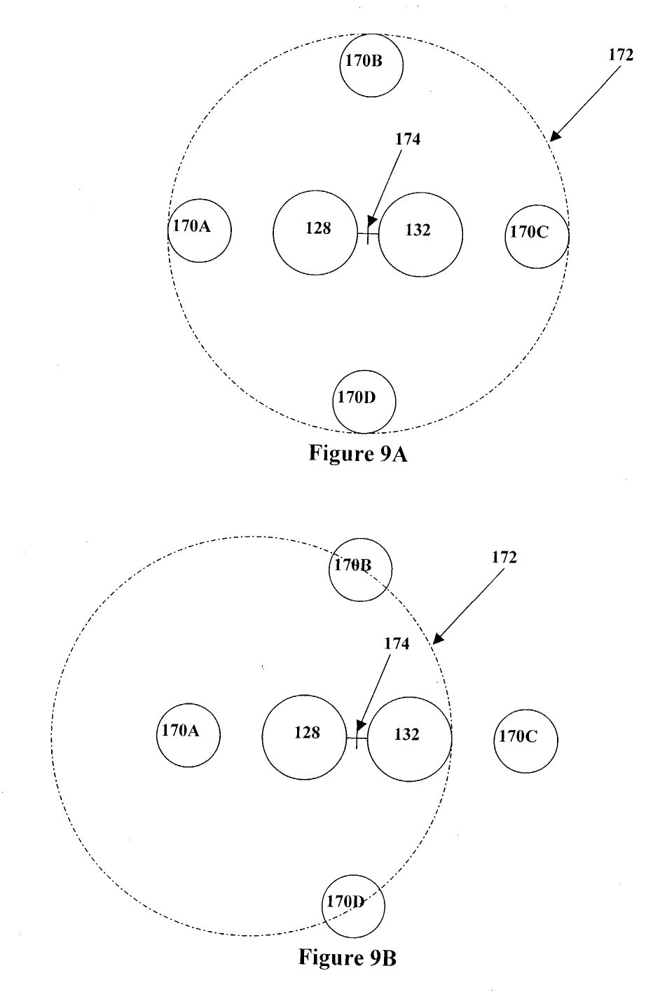

FIGS. 9A and 9B illustrate such an arrangement. As shown therein, the first and second radiation detectors 128 and 132 are surrounded by four alignment radiation detectors 170A, 170B, 170C, and 170D, which are distributed in an annular arrangement about the first and second radiation detectors 128 and 132. Thus, the alignment radiation detectors 170A, 170B, 170C, and 170D are all equally distant from the geometric center 174 of the radiation detector arrangement. Likewise, the alignment radiation detectors 170A, 170B, 170C, and 170D are spaced about the geometric center 174 at uniform angular intervals, 90 degree intervals as illustrated.

In the arrangement shown, the radiation from the transmitter 100 illuminates a generally circular area 172. In order for the receiver 120 to function, both the first and second radiation detectors 128 and 132 must be within that illuminated area 172. Preferably, the illuminated area 172 will be at least approximately centered on the first and second radiation detectors 128 and 132, so that the first and second radiation detectors 128 and 132 receive similar intensities of radiation.

Because the alignment radiation detectors 170A, 170B, 170C, and 170D are disposed at equal distances from the geometric center 174 of the radiation detector arrangement, when the illuminated area 172 is centered on the geometric center 174 of the radiation detector arrangement—in other words, when the transmitter 100 and the receiver 120 are aligned—all four of the alignment radiation detectors 170A, 170B, 170C, and 170D will receive equal intensities of radiation. Such a circumstance is illustrated in FIG. 9A.

However, if the illuminated area 172 is not centered on the geometric center 174 of the radiation detector arrangement—the transmitter 100 and the receiver 120 are not aligned—the alignment radiation detectors 170A, 170B, 170C, and 170D will not all receive equal intensities of radiation. Such a circumstance is illustrated in FIG. 9B.

In the circumstance illustrated in FIG. 9B, alignment radiation detector 170C is completely outside of the illuminated area 172, and therefore receives zero radiation. Alignment radiation detectors 170B and 170D are partially within the illuminated area 172, and therefore receive some radiation. Furthermore, as illustrated approximately the same areas of alignment radiation detectors 170B and 170D are within the illuminated area 172, and therefore they receive approximately the same amount of radiation. In contrast, alignment radiation detector 170A is completely inside the illuminated area 172, and therefore receives more radiation than alignment radiation detectors 170B and 170D.

By determining that the amount of radiation received by the four alignment radiation detectors 170A, 170B, 170C, and 170D is not equal, it can be deduced that the transmitter 100 and the receiver 120 are not aligned. Furthermore, by determining the relative amounts of radiation received by the four alignment radiation detectors 170A, 170B, 170C, and 170D, the approximate direction and degree of misalignment can be deduced.

It is noted that the circumstances shown in FIGS. 9A and 9B are illustrative only. In practice, the illuminated area 172 may not be uniform, or perfectly circular, as shown. Likewise, although the illuminated area 172 is shown to be exactly large enough to completely cover all four alignment radiation detectors 170A, 170B, 170C, and 170D when it is centered on the geometric center 174, this is exemplary only. It may be equally suitable for the illuminated area 172 to be larger or smaller.

Regardless, such an arrangement of alignment radiation detectors 170A, 170B, 170C, and 170D may be advantageous for initially aligning the transmitter 100 and the receiver 120 with one another. Furthermore, such an arrangement of alignment radiation detectors 170A, 170B, 170C, and 170D may be advantageous in detecting whether and to what degree the transmitter 100 and the receiver 120 have become misaligned during operation.

However, such an arrangement is exemplary only. Other numbers and distributions of alignment radiation sensors may be equally suitable. Likewise, omitting alignment radiation sensors altogether may be suitable for certain embodiments.

It is emphasized that the alignment radiation detectors 170A, 170B, 170C, and 170D need not be suitable for detecting gas—although in certain embodiments they might be—so long as they are suitable for detecting radiation to the degree necessary for purposes of determining beam alignment.

The path length of an embodiment in accordance with the principles of the claimed invention may vary widely. There is essentially no lower limit to the path length. The maximum path length is also not limited in principle, although in practice it may be limited by the particular optical properties of components used to construct a given embodiment, and the optical conditions prevalent along the path.

For example, as path length increases, beam divergence of the radiation emitted by the radiation source 102 decreases the amount of radiation that can be detected by first and second radiation detectors 128 and 132 of a given size. As the received radiation decreases, signal strength likewise decreases, until at some point no useful information can be obtained. However, it will be appreciated that this is not a fundamental limit of the invention, but rather depends on the beam collimation of the radiation source 102 and the sensitivity of the first and second radiation detectors 128 and 132.

Additionally, as the path length increases, the portion of the field of view of each of the first and second radiation detectors 128 and 132 that is occupied by the radiation source 102 decreases. At some point, spurious signals generated by noise, i.e. from sources other than the radiation source 102, overwhelm the radiation source 102 itself. However, this limitation is likewise based upon the particulars of the system, in this case the field of view of the first and second radiation detectors 128 and 132, and the intensity of the radiation source 102. It does not represent a fundamental range limit for the invention.

Certain suitable embodiments of the claimed invention have functional path lengths of approximately 120 meters. It is stressed that this path length is neither an ultimate maximum nor a minimum, and that embodiments having longer or shorter path lengths may be equally suitable.

It is also pointed out that the precise path length for a particular embodiment is to some degree dependent upon attenuation due to environmental conditions along the path, such as the presence of rain, fog, dust, etc.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A method for detecting at least one gas, comprising the steps of:
passing radiation through an area;
sensing radiation that has passed through said area within a first spectral band, said first spectral band being defined by a first long cut-off wavelength and a first short cut-off wavelength, and measuring a first intensity of said radiation in said first spectral band;
sensing radiation that has passed through said area within a second spectral band, said second spectral band being defined by a second long cut-off wavelength and a second short cut-off wavelength, and measuring a second intensity of said radiation in said second spectral band;
comparing said first and second intensities with at least one threshold value;
indicating a presence of said at least one gas in said area based on said comparison of said first and second intensities with said at least one threshold value;
wherein said second long cut-off wavelength is longer than said first long cut-off wavelength, and said second short cut-off wavelength is shorter than said first short cut-off wavelength.

2. The method according to claim 1, wherein
said first spectral band corresponds to an absorption peak for said at least one gas.

3. The method according to claim 1, wherein
said first spectral band corresponds to wavelengths not strongly absorbed by water.

4. The method according to claim 1, wherein
said second spectral band corresponds to wavelengths not strongly absorbed by water.

5. The method according to claim 1, wherein
said first spectral band includes a wavelength of 2.30 μm.

6. The method according to claim 1, wherein
said second spectral band includes a wavelength of 2.30 μm.

7. The method according to claim 1, wherein
a center of said first spectral band is at approximately 2.30 μm.

8. The method according to claim 1, wherein
a center of said second spectral band is at approximately 2.30 μm.

9. The method according to claim 1, wherein
a difference between said second long cut-off wavelength and said second short cut-off wavelength is at least twice a difference between said first long cut-off wavelength and said first short cut-off wavelength.

10. The method according to claim 1, wherein
a difference between said second long cut-off wavelength and said second short cut-off wavelength is at least three times a difference between said first long cut-off wavelength and said first short cut-off wavelength.

11. The method according to claim 1, wherein
a difference between said first long cut-off wavelength and said first short cut-off wavelength is approximately 0.10 μm.

12. The method according to claim 1, wherein
a difference between said second long cut-off wavelength and said second short cut-off wavelength is approximately 0.30 μm.

13. A method for detecting a plurality of gases, comprising the steps of:
passing radiation through an area;
sensing radiation that has passed through said area within a plurality of first spectral bands, each of said first spectral bands being defined by a first long cut-off wavelength and a first short cut-off wavelength, and measuring a first intensity of said radiation in each of said first spectral bands;
sensing radiation that has passed through said area within a plurality of second spectral bands, wherein each of said second spectral bands is associated with one of said first spectral bands and each of said second spectral bands is defined by a second long cut-off wavelength and a second short cut-off wavelength, and measuring a second intensity of said radiation in each of said second spectral bands;
comparing said each of said first intensities and said second intensity associated therewith with at least one threshold value;
for each of said first intensities and said second intensity associated therewith, indicating a presence of at least one of said gases in said area based on said comparison of said first and second intensities with said at least one threshold value;
wherein for each of said second spectral bands, said second long cut-off wavelength is longer than said first long cut-off wavelength of said first spectral band associated therewith, and said second short cut-off wavelength is shorter than said first short cut-off wavelength of said first spectral band associated therewith.

14. An apparatus for detecting gas, comprising:
a radiation source;
a first radiation detector sensitive to radiation in a first spectral band, said first spectral band being defined by a first long cut-off wavelength and a first short cut-off wavelength, said first radiation detector generating a first intensity signal corresponding to an intensity of radiation detected in said first spectral band;
a second radiation detector sensitive to radiation in a second spectral band, said second spectral band being defined by a second long cut-off wavelength and a second short cut-off wavelength, said second radiation detector generating a second intensity signal corresponding to an intensity of radiation detected in said second spectral band;
a processor in communication with said first and second radiation detectors, said processor being adapted to compare said first and second intensity signals with at least one threshold value, and to generate an output signal indicating a presence of gas based on said comparison of said first and second intensity signals with said at least one threshold value;
wherein said second long cut-off wavelength is longer than said first long cut-off wavelength, and said second short cut-off wavelength is shorter than said first short cut-off wavelength.

15. The apparatus according to claim 14, wherein
said first spectral band corresponds to an absorption peak for said at least one gas.

16. The apparatus according to claim 14, wherein
said first spectral band corresponds to wavelengths not strongly absorbed by water.

17. The apparatus according to claim 14, wherein
said second spectral band corresponds to wavelengths not strongly absorbed by water.

18. The method according to claim 14, wherein
said first spectral band includes a wavelength of 2.30 μm.

19. The method according to claim 14, wherein
said second spectral band includes a wavelength of 2.30 μm.

20. The apparatus according to claim 14, wherein
a center of said first spectral band is at approximately 2.30 μm.

21. The apparatus according to claim 14, wherein
a center of said second spectral band is at approximately 2.30 μm.

22. The apparatus according to claim 14, wherein
a difference between said second long cut-off wavelength and said second short cut-off wavelength is at least twice a difference between said first long cut-off wavelength and said first short cut-off wavelength.

23. The apparatus according to claim 14, wherein
a difference between said second long cut-off wavelength and said second short cut-off wavelength is at least three times a difference between said first long cut-off wavelength and said first short cut-off wavelength.

24. The apparatus according to claim 14, wherein
a difference between said first long cut-off wavelength and said first short cut-off wavelength is approximately 0.10 μm.

25. The apparatus according to claim 14, wherein
a difference between said second long cut-off wavelength and said second short cut-off wavelength is approximately 0.30 μm.

26. An apparatus for detecting a plurality of gases, comprising:
a radiation source;
a plurality of first radiation detectors, each of said first radiation detectors being sensitive to radiation in a first spectral band, each of said first spectral bands being defined by a first long cut-off wavelength and a first short cut-off wavelength, each of said first radiation detectors generating a first intensity signal corresponding to an intensity of radiation detected in said first spectral band thereof;
a plurality of second radiation detectors, each of said second radiation detectors being associated with one of said first radiation detectors, each of said second radiation detectors being sensitive to radiation in a second spectral band, each of said second spectral bands being defined by a second long cut-off wavelength and a second short cut-off wavelength, each of said second radiation detectors generating a second intensity signal corresponding to an intensity of radiation detected in said second spectral band thereof;
a processor in communication with each of said first and second radiation detectors, said processor being adapted to compare each of said first intensity signals and said second intensity signal associated therewith with at least one threshold value, and to generate a plurality of output signals, each of said output signals indicating a presence of at least one of said gases based on said comparison of said first intensity signals and second intensity signals associated therewith with said at least one threshold value;
wherein said for each of said second spectral bands, said second long cut-off wavelength is longer than said first long cut-off wavelength of said first spectral band associated therewith, and said second short cut-off wavelength is shorter than said first short cut-off wavelength of said first spectral band associated therewith.
